(19) United States
(12) Patent Application Publication
(10) Pub. No.: US 2022/0307449 A1
(43) Pub. Date: Sep. 29, 2022

(54) ROCKET MOTOR AUXILIARY POWER GENERATION UNIT SYSTEMS AND METHODS

(71) Applicant: Goodrich Corporation, Charlotte, NC (US)

(72) Inventors: Matthew D. Salois, Fairfield, CA (US); Luis G. Interiano, Gait, CA (US)

(73) Assignee: Goodrich Corporation, Charlotte, NC (US)

(21) Appl. No.: 17/213,081

(22) Filed: Mar. 25, 2021

(51) Int. Cl. F02K 9/32; F02K 9/94; F02K 9/95; F02C 9/26; F02C 1/00

(52) U.S. Cl. CPC F02K 9/32; F02K 9/94; F02K 9/95; F02C 9/263; F02C 1/002; F05D 2220/76; F05D 2260/99; F05D 2270/62; F05D 2220/50

(57) ABSTRACT

A method for generating electric power for a rocket system includes burning a primary solid propellant grain to create a primary high pressure gas for providing thrust to the rocket, opening a first valve to divert a portion of the high pressure gas to an auxiliary solid propellant grain for igniting the auxiliary solid propellant grain, wherein the auxiliary solid propellant grain is disposed in a housing separate from the primary solid propellant grain, and burning the auxiliary solid propellant grain to create an auxiliary high pressure gas for turning a turbine. The method further includes driving a generator with the turbine and generating an electric power with the generator.

### FIELD

The present disclosure relates generally to solid fuel rocket propulsion systems, and more particularly, to systems and methods for power generation for rocket motor systems.

### BACKGROUND

Solid propellant motors for rocket-propelled vehicles include a solid propellant grain which generates high pressure gas, which is expelled through a nozzle to generate thrust for the rocket. Rocket-propelled vehicles typically include various electric systems. Powering electric systems for rocket-propelled vehicles has traditionally been accomplished using battery technologies.

### SUMMARY

A system connectable with a rocket is disclosed herein. The system comprises a primary motor comprising a primary solid propellant grain configured to burn to create a primary high pressure gas, an auxiliary gas generator comprising an auxiliary solid propellant grain disposed in a housing separate from the primary solid propellant grain, a first valve, an electric generator, and a turbine coupled to the electric generator. In response to the first valve moving to an open position, the primary motor is in fluid communication with the auxiliary gas generator for igniting the auxiliary solid propellant grain. In response to the auxiliary solid propellant grain being ignited by the primary high pressure gas, the auxiliary solid propellant grain is configured to burn to create an auxiliary high pressure gas.

In various embodiments, the system further comprises a second valve for metering the auxiliary high pressure gas to the turbine.

In various embodiments, the auxiliary high pressure gas is configured to be directed to the turbine in response to the second valve moving to an open position.

In various embodiments, the system further comprises a third valve for dumping pressure from the housing to extinguish the auxiliary solid propellant grain.

In various embodiments, the auxiliary solid propellant grain is hermetically sealed from the primary solid propellant grain in response to the first valve moving to a closed position.

In various embodiments, the system further comprises a controller configured to control at least one of the first valve, the second valve, and the third valve for selectively powering the generator.

In various embodiments, the system further comprises a power supply configured to supply a second electric power to the controller.

An auxiliary power generation arrangement is disclosed herein, comprising an auxiliary solid propellant grain disposed in a housing, a first valve configured to move to an open position for directing a primary high pressure gas to the auxiliary solid propellant grain to ignite the auxiliary solid propellant grain, an electric generator, and a turbine coupled to the electric generator. The auxiliary solid propellant grain is configured to burn to create an auxiliary high pressure gas for turning the turbine.

In various embodiments, the auxiliary power generation arrangement further comprises a second valve in fluid communication with the turbine.

In various embodiments, the auxiliary power generation arrangement further comprises a third valve for dumping pressure from the housing to extinguish the auxiliary solid propellant grain.

In various embodiments, the auxiliary solid propellant grain is re-ignitable after being extinguished.

In various embodiments, the auxiliary solid propellant grain is hermetically sealed from a primary solid propellant grain in response to the first valve moving to a closed position.

In various embodiments, the auxiliary power generation arrangement further comprises a controller configured to control at least one of the first valve, the second valve, and the third valve for selectively powering the electric generator.

In various embodiments, the auxiliary power generation arrangement further comprises a power supply configured to supply a second electric power to the controller.

In various embodiments, the second valve is configured to meter the auxiliary high pressure gas to the turbine.

In various embodiments, the third valve is configured to direct the auxiliary high pressure gas to an ambient environment.

A method for generating electric power for a rocket-propelled vehicle is disclosed herein. The method comprises burning a primary solid propellant grain to create a primary high pressure gas for providing thrust to the rocket, opening a first valve to divert a portion of the primary high pressure gas to an auxiliary solid propellant grain for igniting the auxiliary solid propellant grain, wherein the auxiliary solid propellant grain is disposed in a housing separate from the primary solid propellant grain, burning the auxiliary solid propellant grain to create an auxiliary high pressure gas, turning a turbine using the auxiliary high pressure gas, driving a generator with the turbine, and generating electric power with the generator.

In various embodiments, the method further comprises closing the first valve, hermetically sealing the auxiliary solid propellant grain from the primary solid propellant grain in response to the first valve closing, opening a second valve, and directing the auxiliary high pressure gas across the turbine in response to the second valve opening.

In various embodiments, the method further comprises closing the second valve, opening a third valve to decrease a pressure within the housing, and extinguishing the auxiliary solid propellant grain in response to the pressure decreasing within the housing.

In various embodiments, the method further comprises closing the third valve, re-opening the first valve to divert a second portion of the primary high pressure gas to the auxiliary solid propellant grain, and re-igniting the auxiliary solid propellant grain in response to the second portion of the primary high pressure gas being diverted to the auxiliary solid propellant grain.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1A illustrates a schematic view of a rocket propulsion system including a primary motor and an auxiliary power generation arrangement including an auxiliary gas generator, in accordance with various embodiments;

FIG. 1B illustrates a schematic view of the rocket system of FIG. 1A with the auxiliary power generation arrangement in an ignition mode, in accordance with various embodiments;

FIG. 1C illustrates a schematic view of the rocket system of FIG. 1A with the auxiliary power generation arrangement in a power generation mode, in accordance with various embodiments;

FIG. 1D illustrates a schematic view of the rocket system of FIG. 1A with the auxiliary power generation arrangement in an extinguish mode, in accordance with various embodiments;

FIG. 2 illustrates a method for generating electric power for a rocket system, in accordance with various embodiments; and

FIG. 3 illustrates a block diagram of an exemplary turbine generator assembly, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the scope of the disclosure. Thus, the detailed description herein is presented for purposes of illustration only and not of limitation. For example, the steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

Typically, a rocket-propelled vehicle includes an onboard power source comprising traditional battery technologies (e.g., lithium-ion batteries, or any other suitable battery) and/or thermal batteries. Traditional batteries and thermal batteries tend to have limitations in power density, environment capabilities, size, performance, life, and the ability to turn on and/or off. Due to the limitations of current battery technologies with regard to weight, volume, cost, and reliability, there is a need to develop a more affordable and power/energy dense electric power source.

The present disclosure provides an auxiliary power generation unit comprising a solid fuel. The auxiliary power generation unit is disposed separate from a primary rocket motor which generates thrusts during the course of the rocket motor's flight. In various embodiments of the present disclosure, the auxiliary power generation unit comprises an auxiliary gas generator comprising a solid propellant grain which is ignited by gas from a primary motor. In various embodiments of the present disclosure, the auxiliary power generation unit comprises a plurality of valves for selectively igniting the auxiliary solid propellant grain of the auxiliary gas generator, power generation when the auxiliary solid propellant grain is ignited (i.e., burning), and extinguishing the auxiliary solid propellant grain. In this manner, the auxiliary power generation unit of the present disclosure may be ignitable and extinguishable on demand (i.e., capable of multiple, discrete uses during a single flight of a rocket). In various embodiments of the present disclosure, the primary motor is used for igniting the auxiliary solid propellant grain of the auxiliary gas generator and is not used for supplementing, refilling, or recharging the auxiliary solid propellant grain. In this manner, the auxiliary solid propellant grain is separate from, and independent of, the primary solid propellant grain, in accordance with various embodiments.

The auxiliary power generation unit of the present disclosure may be used in addition to (i.e., to supplement) traditional onboard power sources (e.g., traditional batteries and/or thermal batteries). In this regard, the present disclosure provides systems and methods for utilizing a solid propellant grain and a small turbine generator to produce needed electrical power on demand. Systems and methods of the present disclosure tend to reduce the weight of the power source for a rocket as propellant is consumed during the process of power generation. Propellant grain has a high stored energy to volume/weight ratio making it an efficient article for power generation. Traditional batteries tend to struggle with extreme environments that a solid propellant grain is able to withstand. The auxiliary power generation unit of the present disclosure may utilize a hot gas from the primary motor to initiate the auxiliary gas generator and may utilize the ambient outside air to extinguish the auxiliary gas generator, reducing the complexity and additional parts that would otherwise be necessary. The system of the present disclosure may also be tailored to size depending on expected power consumption needs.

The present disclosure provides a turbine generator for providing electric power to the system, a turbine for driving the generator, and the auxiliary solid propellant grain for creating an auxiliary high pressure gas for turning the turbine, and, in response to the rotation, the generator generates electricity.

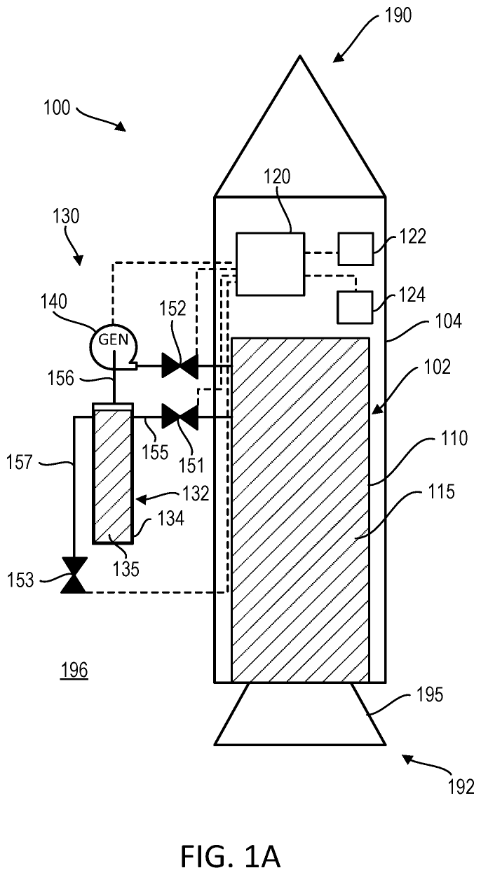

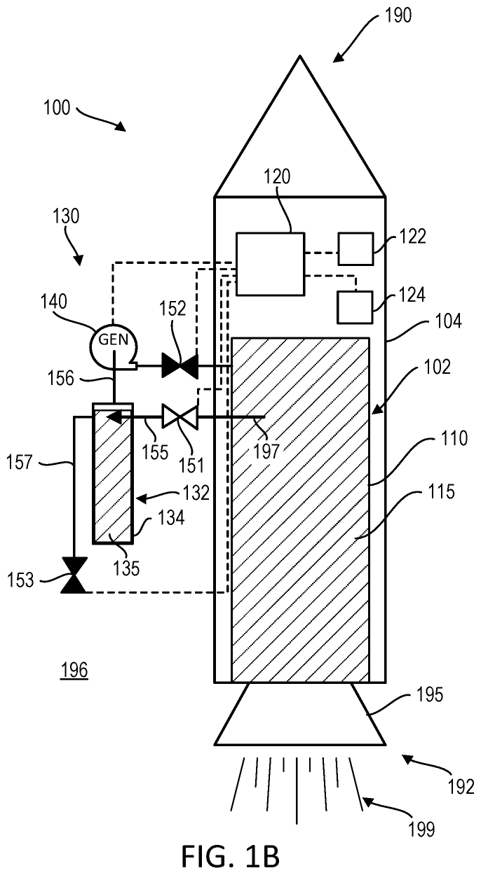

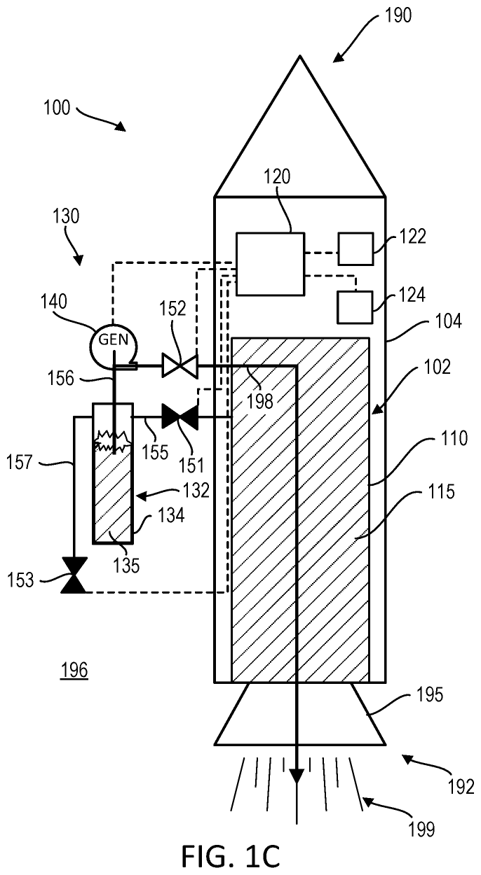

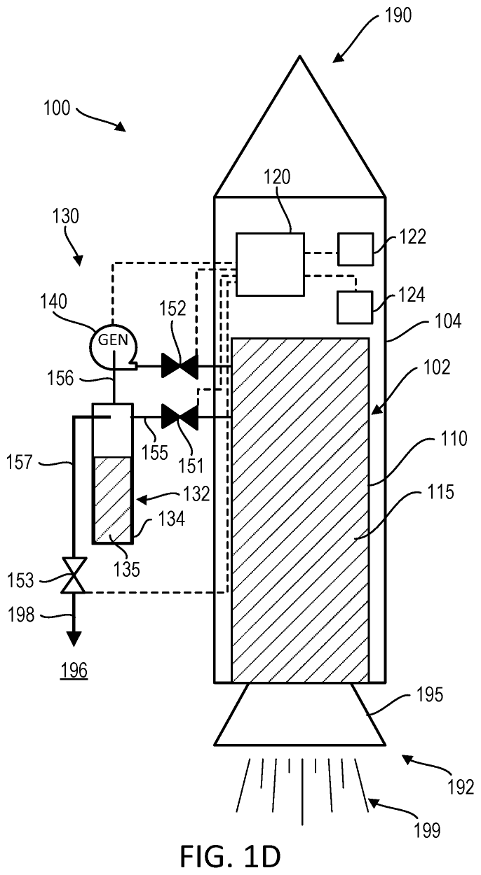

With reference to FIG. 1A, a rocket-propelled vehicle 100 (also referred to herein as a rocket), shown schematically in FIG. 1A, including a primary motor 102 and an auxiliary power generation unit 130 is illustrated, in accordance with various embodiments. In FIG. 1A, electrical connections (e.g., an electrically conductive material, a wire, a cable, a bus bar, etc.) are depicted with dashed-lines, while fluid connections (e.g., a conduit, a channel, etc.) are depicted with solid lines. Primary motor 102, shown schematically in FIG. 1A, may comprise a solid propellant rocket motor 110 including a solid propellant grain 115 (also referred to herein as a primary solid propellant grain), in accordance with various embodiments. Rocket 100 may comprise a forward end 190 and an exhaust end 192. Rocket 100 may comprise an aerodynamic body 104. Propellant grain 115 may extend along a longitudinal axis of the solid propellant rocket motor 110 between the exhaust end 192 and the forward end 190. Propellant grain 115 may be a core-burning propellant grain or an end-burning propellant grain, or any other suitable configuration propellant grain. In various embodiments, when propellant grain 115 is a core-burning propellant grain, the propellant grain 115 comprises a hollow core region, commonly referred to as a center perforation. The center perforation may define a bore extending longitudinally through core-burning propellant grain. An ignitor may be disposed in or on propellant grain 115 for igniting propellant grain 115 to generate thrust for the rocket 100. It should be noted, at this point, that the ignitor and the electrical connections have not been shown. The particular ignitor and electrical connections are well known in the art and can be selected in accordance with the particular propellant/oxidizer utilized, and other desired design features.

Forward end 190 of rocket 100 may be sealed and exhaust end 192 may be terminated by a nozzle structure 195. Upon ignition—e.g., by an ignitor—a surface of the propellant grain 115 begins burning, thereby becoming the burn front, which is the surface of the propellant grain being combusted or burned at any given time. The burning then continues yielding gaseous combustion by-products at high temperature and pressure (also referred to herein as a primary high pressure gas). The expulsion of these gaseous combustion by-products through the nozzle structure 195 provides the thrust of the primary motor 102 and rocket 100.

Rocket 100 may further comprise a control unit 120 for controlling various electronic components of rocket 100. Control unit 120 includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the control unit 120 controls, at least various parts of, the flight of, and operation of various components of, the rocket 100. For example, the control unit 120 may control various components of auxiliary power generation arrangement 130, shown schematically in FIG. 1A, and/or various parameters of flight, such as thrust systems, electrical systems, environmental systems, hydraulics systems, lighting systems, pneumatics systems, trim systems, actuator systems, and the like.

In various embodiments, rocket 100 further comprises a power source 122 (also referred to herein as a primary power source) for powering controller 120 and/or other electronic components disposed onboard rocket 100. In various embodiments, primary power source 122 may comprise one or more batteries (e.g., alkaline, zinc-carbon, lithium, mercury oxide, silver oxide, zinc-air, lithium-ion (Li-ion), nickel-metal hydride (NIMH), nickel-cadmium (NiCD), lead-acid, etc.), capacitors (e.g., ceramic, film, electrolytic, super, etc.), thermal batteries (e.g., phase change, encapsulated, ground heat exchanger (GHEX)—unencapsulated, etc.) or the like. Primary power source 122 may be electrically coupled to control unit 120 for supplying electric power thereto. Primary power source 122 may have limitations in power density, environment capabilities, size, performance, life, and the ability to turn on/off.

In various embodiments, auxiliary power generation arrangement 130 includes an auxiliary gas generator 132 including a propellant grain 135 (also referred to herein as an auxiliary solid propellant grain) disposed in a housing 134 separate from the primary solid propellant grain 115. In various embodiments, auxiliary power generation arrangement 130 further includes a turbine generator 140 for providing electric power to control unit 120 and/or an onboard electrical component 124, such as an actuator, payload, separation system, guidance system, or any other electrical or electromechanical component onboard the rocket. In response to a need for additional power to rocket 100, control unit 120 may cause auxiliary power generation arrangement 130 to generate additional electricity to produce the needed power, as described in further detail herein.

Housing 134 may comprise any suitable structure for containing propellant grain 135. Housing 134 may comprise a casing for propellant grain 135. Housing 134 may be made either from metal (e.g., high-resistance steels or high strength aluminum alloys) or from composite materials (e.g., glass fibers, aramid fibers, and/or carbon fibers).

Auxiliary power generation arrangement 130 may further comprise a first valve 151 that provides a flow path for primary high pressure gas between propellant grain 115 and propellant grain 135. First valve 151 may be controlled by control unit 120. First valve 151 may be coupled between primary motor 102 and auxiliary gas generator 132. First valve 151 may comprise a needle valve, ball valve, gate valve, butterfly valve, or any other suitable valve that can withstand the high temperature of the primary high pressure gas generated by propellant grain 115. First valve 151 may be movable between an open position (e.g., see FIG. 1B) and a closed position (e.g., see FIG. 1C and FIG. 1D). In this regard, propellant grain 115 may be in fluid communication with propellant grain 135 in response to first valve 151 moving to the open position. Conversely, propellant grain 115 may be hermetically sealed from propellant grain 135 in response to first valve 151 moving to the closed position. In this regard, a conduit 155, or other suitable flow structure, may be coupled between primary motor 102 and auxiliary gas generator 132.

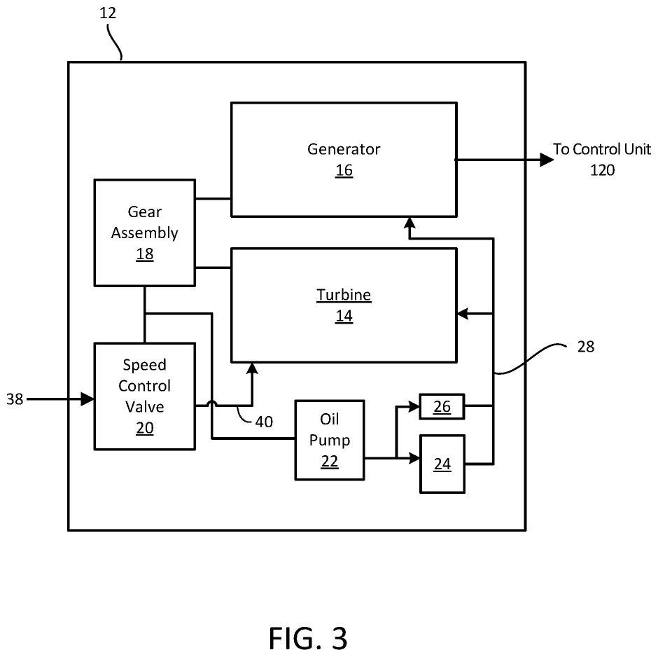

Auxiliary power generation arrangement 130 may further comprise a second valve 152 for exhausting gaseous combustion by-products at high temperature and pressure (also referred to herein as an auxiliary high pressure gas) from housing 134—e.g., when auxiliary power generation arrangement 130 is in a power generation mode. Second valve 152 may be controlled by control unit 120. Second valve 152 may be coupled between primary motor 102 and auxiliary gas generator 132. In this regard, second valve 152 may be configured to direct auxiliary high pressure gas from propellant grain 135 into rocket motor 110 and subsequently out the rocket motor 110 through nozzle structure 195. In various embodiments, second valve 152 meters the auxiliary high pressure gas to a turbine (see turbine 14 of FIG. 3) of generator 140. In this regard, auxiliary high pressure gas produced by propellant grain 135 may be directed through nozzle structure 195. Second valve 152 may comprise a needle valve, ball valve, gate valve, butterfly valve, or any other suitable valve that can withstand the high temperature and high pressure of the auxiliary high pressure gas generated by propellant grain 135. Second valve 152 may be movable between an open position (see FIG. 1C) and a closed position (see FIG. 1B and FIG. 1D). In this regard, primary motor 102 may be in fluid communication with propellant grain 135 in response to second valve 152 moving to the open position. In this regard, nozzle structure 195 may be in fluid communication with propellant grain 135 in response to second valve 152 moving to the open position. Conversely, primary motor 102 may be hermetically sealed from auxiliary gas generator 132 in response to second valve 152 moving to the closed position. In this regard, a conduit 156, or other suitable flow structure, may be coupled between primary motor 102 and auxiliary gas generator 132.

Auxiliary power generation arrangement 130 may further comprise a third valve 153 for exhausting the auxiliary high pressure gas from housing 134—e.g., in order to extinguish propellant grain 135. Third valve 153 may be controlled by control unit 120. Third valve 153 may be coupled to housing 134. In this regard, third valve 153 may be configured to direct auxiliary high pressure gas from auxiliary gas generator 132 to an ambient environment 196. In this regard, auxiliary high pressure gas produced by propellant grain 135 may be exhausted through third valve 153. Third valve 153 may comprise a ball valve, gate valve, butterfly valve, or any other suitable valve that can withstand the high temperature and high pressure of the auxiliary high pressure gas generated by propellant grain 135 and that can open to quickly reduce pressure within housing 134—e.g., to ambient pressure—to extinguish propellant grain 135. Third valve 153 may be movable between an open position (see FIG. 1D) and a closed position (see FIG. 1B and FIG. 1C). In this regard, propellant grain 135 may be in fluid communication with the ambient environment 196 in response to third valve 153 moving to the open position. Conversely, propellant grain 135 may be hermetically sealed from the ambient environment 196 in response to third valve 153 moving to the closed position. In this regard, a conduit 157, or other suitable flow structure, may be coupled between housing 134 and third valve 153. Alternatively, third valve 153 may be coupled directly to housing 134 and conduit 157 may extend from third valve 153.

Auxiliary power generation arrangement 130 further comprises generator 140 (also referred to herein as a turbine generator or an electric generator), in accordance with various embodiments. Generator 140 may be a turbine generator. Generator 140 may be a small generator suitable for mounting to the body 104 of rocket 100. Generator 140 may be coupled in-line with second valve 152. In this regard, in response to second valve 152 moving to an open position, auxiliary high pressure gas generated by propellant grain 135 may expand across the generator turbine, thereby causing the turbine to rotate, causing generator 140 to generate electric power and provide the electric power to control unit 120 and/or component 124. Stated differently, the turbine converts available energy in the high pressure exhaust gas into rotation while the generator converts rotation into electricity. Turbine generators are known in the art and can be selected in accordance with the expected pressures, expected flow rates, expected electric power requirements, weight requirements, and other desired design features.

Auxiliary power generation arrangement 130 may operate in various modes depending on whether additional electric power is desired. With reference to FIG. 1B, rocket 100 is illustrated with the auxiliary power generation arrangement 130 in an ignition mode for igniting propellant grain 135. In the ignition mode, first valve 151 is moved to the open position. Control unit 120 may command first valve 151 to the open position (e.g., by a voltage signal or current signal). With the first valve 151 in the open position, and propellant grain 115 ignited, primary high pressure gas (illustrated in FIG. 1B by arrow 197) generated by propellant grain 115 flows from primary motor 102, through first valve 151, into housing 134 and ignites propellant grain 135. Stated differently, in response to first valve 151 moving to the open position, a portion 197 of the primary high pressure gas 199 is diverted to the auxiliary solid propellant grain 135 for igniting the auxiliary solid propellant grain 135. In this regard, propellant grain 135 may be selected to be ignitable at a temperature of primary high pressure (and high temperature) gas 197. Once propellant grain 135 is ignited, control unit 120 may command auxiliary power generation arrangement 130 to switch from the ignition mode to a power generation mode.

With reference to FIG. 1C, rocket 100 is illustrated with the auxiliary power generation arrangement 130 in a power generation mode for generating additional electric power for rocket 100. To switch from the ignition mode to the power generation mode, first valve 151 is moved to the closed position and second valve 152 is moved to the open position. Control unit 120 may command first valve 151 to the closed position (e.g., by a voltage signal or current signal). Control unit 120 may command second valve 152 to the open position (e.g., by a voltage signal or current signal). With the first valve 151 in the closed position, the second valve 152 in the open position, the third valve 153 in the closed position, and propellant grain 135 ignited, auxiliary high pressure gas (illustrated in FIG. 1C by arrow 198) generated by propellant grain 135 flows from auxiliary gas generator 132, through generator 140, causing the generator turbine (see turbine 14 of FIG. 3) to rotate and generate electric power for rocket 100. Auxiliary high pressure gas 198 may flow through second valve 152, into primary motor 102, and be exhausted through nozzle structure 195. Stated differently, in response to the auxiliary solid propellant grain 135 being ignited, the auxiliary solid propellant grain 135 is configured to burn to create auxiliary high pressure gas 198 for turning the turbine (see turbine 14 of FIG. 3) of generator 140. As propellant grain 135 burns, auxiliary high pressure gas 198 continues to expand across the generator turbine of generator 140 to generate electric power. Furthermore, the weight of auxiliary power generation arrangement 130 decreases as auxiliary high pressure gas 198 leaves auxiliary power generation arrangement 130 and exits nozzle structure 195. In various embodiments, auxiliary power generation arrangement 130 may operate in the power generation mode for a duration (e.g., seconds) and then be selectively powered off by switching from the power generation mode to an extinguish mode (see FIG. 1D).

With reference to FIG. 1D, rocket 100 is illustrated with the auxiliary power generation arrangement 130 in an extinguish mode for extinguishing propellant grain 135. To switch from the power generation mode to the extinguish mode, second valve 152 is moved to the closed position and third valve 153 is moved to the open position. First valve 151 remains in the closed position. Control unit 120 may command second valve 152 to the closed position. Control unit 120 may command third valve 153 to the open position (e.g., by a voltage signal or current signal). With the first valve 151 in the closed position, the second valve 152 in the closed position, the third valve 153 in the open position, and propellant grain 135 ignited, auxiliary high pressure gas 198 generated by propellant grain 135 exits housing, through third valve 153, and is dumped into the ambient environment 196, causing the pressure within housing 134 to quickly decrease to, or near to, ambient pressure. Stated differently, third valve 153 may dump pressure from housing 134 to extinguish the auxiliary solid propellant grain 135. In response to the decrease in pressure, propellant grain 135 may be extinguished to reserve the leftover propellant grain 135 for a subsequent power generation cycle. With the auxiliary power generation arrangement 130 effectively turned off, auxiliary power generation arrangement 130 may later be turned back on by switching to the ignition mode and power generation mode, allowing for multiple, discrete uses of the power generation arrangement 130 whereby electric power is generated on demand. In this regard, propellant grain 135 may be selectively “turned on” and “turned off”—e.g., by control unit 120—depending on the power needs of rocket 100. Stated differently, propellant grain 135 is re-ignitable after being extinguished.

In various embodiments, propellant grain 115 and/or propellant grain 135 may be comprised of a composite propellant comprising both a fuel and an oxidizer mixed and immobilized within a cured polymer-based binder. For example, propellant grain 115 and/or propellant grain 135 may comprise an ammonium nitrate-based composite propellant (ANCP) or ammonium perchlorate-based composite propellant (APCP). In various embodiments, propellant grain 115 and/or propellant grain 135 may comprise a distribution of AP (NH₄ClO₄) grains embedded in a hydroxyl-terminated polybutadiene (HTPB) matrix.

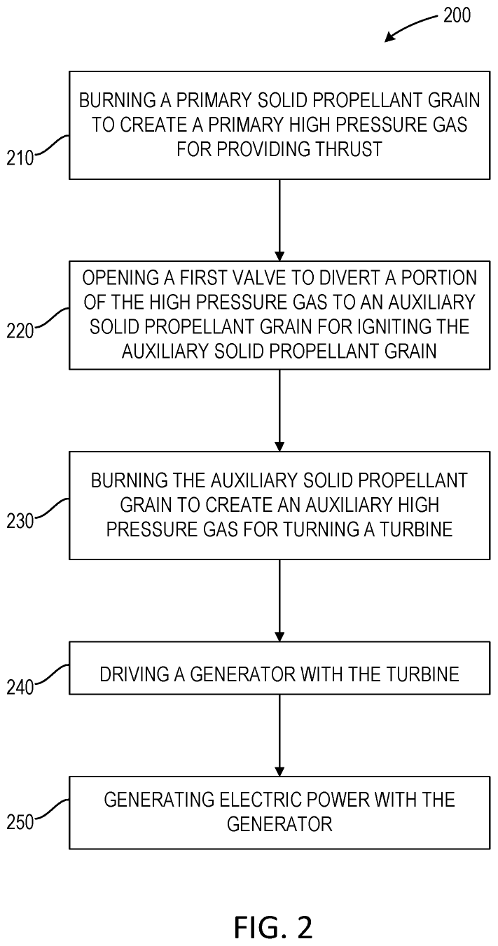

With reference to FIG. 2, a flow chart illustrating a method 200 for generating electric power for a rocket is disclosed, in accordance with various embodiments. Method 200 includes burning a primary solid propellant grain to create a primary high pressure gas for providing thrust to the rocket (step 210). Method 200 includes opening a first valve to divert a portion of the high pressure gas to an auxiliary solid propellant grain for igniting the auxiliary solid propellant grain (step 220). Method 200 includes burning the auxiliary solid propellant grain to create an auxiliary high pressure gas for turning a turbine (step 230). Method 200 includes driving a generator with the turbine (step 240). Method 200 includes generating an electric power with the generator (step 250).

With combined reference to FIG. 1B and FIG. 2, step 210 may include burning primary solid propellant grain 115 to create a primary high pressure gas 199 for providing thrust to rocket 100 (step 210). Step 220 may include opening first valve 151 to divert a portion 197 of the high pressure gas 199 to auxiliary solid propellant grain 135 for igniting the auxiliary solid propellant grain 135. With reference to FIG. 1C and FIG. 2, step 230 may include burning the auxiliary solid propellant grain 135 to create an auxiliary high pressure gas 198 for turning a turbine (see turbine 14 of FIG. 3). Step 240 may include driving generator 140 with the turbine (see turbine 14of FIG. 3). Step 250 may include generating electric power with generator 140.

With reference to FIG. 3, a block diagram of an exemplary turbine generator assembly 12 is illustrated, in accordance with various embodiments. Generator 140 may be similar to turbine generator assembly 12. In various embodiments, second valve 152 may be similar to speed control valve 20. It should be noted, however, that the particular configuration of turbine generator assembly 12 is not particularly limited and various other turbine generator arrangements may be used without departing from the scope of the present disclosure.

Turbine generator assembly 12 includes turbine 14 and generator 16. Turbine generator assembly 12 may further include gear assembly 18, speed control valve 20, lube oil pump 22, lube oil filter 24, lube oil bypass valve 26, and cooling circuit 28), exhaust gas inlet 38, and exhaust gas path 40. In various embodiments, exhaust gas path 40 is a metered exhaust gas path 40. Turbine 14 is any turbine known in the art such as, for example, a single stage, multiple nozzle impulse turbine. Generator 16 is any electric generator known in the art.

A solid propellant grain (e.g., propellant grain 135 of FIG. 1C) is burned to create an auxiliary exhaust gas (e.g., auxiliary high temperature, high pressure gas of FIG. 1C) in an auxiliary propellant grain housing (e.g., housing 134 of FIG. 1C) as described herein. This auxiliary exhaust gas is diverted from the housing and provided to speed control valve 20 through exhaust gas inlet 38. Speed control valve 20 may regulate the amount of gas provided to spin turbine 14. In various embodiments, speed control valve 20 may open without active regulation of the gas provided to spin turbine 14. Turbine 14 powers generator 16 through gear assembly 18. In various embodiments, turbine 14 powers generator 16 without a gear assembly (e.g., is directly coupled to the generator rotor). Generator 16 generates electric power and provides electric power to a system (e.g., rocket 100). The system may utilize the electric power provided by generator 16 to power one or more components onboard a rocket, such as motor-driven linear electromechanical actuators or the like.

Lube oil pump 22 may be a standard lube oil pump known in the art and may be contained in a reservoir housing. Oil pump 22 may provide lubrication and cooling to both turbine 14 and generator 16 through cooling circuit 28. Alternatively, oil pump 22 provides lubrication to only one of turbine 14 and generator 16. Oil may be first passed through filter 24. The oil may then exit gear assembly 18, travel through cooling circuit 28, and then re-enter gear assembly 18. Filter bypass valve 26 may allow oil to bypass filter 24 if filter 24 is clogged. This may be accomplished by measuring the oil pressure at filter bypass valve 26. For example, if the pressure at filter bypass valve 26 is greater than a maximum value, such as 300 pounds per square inch (PSI), unfiltered oil bypasses filter 24 to turbine 14 so as not to starve turbine 14 of oil. A separate valve may set the oil pressure in cooling circuit 28 to, for example, 65 PSI downstream of filter 24.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to invoke 35 U.S.C. 115(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system connectable with a rocket, comprising:
a primary motor comprising a primary solid propellant grain configured to burn to create a primary high pressure gas;
an auxiliary gas generator comprising an auxiliary solid propellant grain disposed in a housing separate from the primary solid propellant grain;
a first valve;
an electric generator; and
a turbine coupled to the electric generator;
wherein,
in response to the first valve moving to an open position, the primary motor is in fluid communication with the auxiliary gas generator for igniting the auxiliary solid propellant grain; and
in response to the auxiliary solid propellant grain being ignited by the primary high pressure gas, the auxiliary solid propellant grain is configured to burn to create an auxiliary high pressure gas.

2. The system of claim 1, further comprising a second valve for metering the auxiliary high pressure gas to the turbine.

3. The system of claim 2, wherein the auxiliary high pressure gas is configured to be directed to the turbine in response to the second valve moving to an open position.

4. The system of claim 3, further comprising a third valve for dumping pressure from the housing to extinguish the auxiliary solid propellant grain.

5. The system of claim 1, wherein the auxiliary solid propellant grain is hermetically sealed from the primary solid propellant grain in response to the first valve moving to a closed position.

6. The system of claim 4, further comprising a controller configured to control at least one of the first valve, the second valve, and the third valve for selectively powering the generator.

7. The system of claim 6, further comprising a power supply configured to supply a second electric power to the controller.

8. An auxiliary power generation arrangement, comprising:
an auxiliary solid propellant grain disposed in a housing;
a first valve configured to move to an open position for directing a primary high pressure gas to the auxiliary solid propellant grain to ignite the auxiliary solid propellant grain;
an electric generator; and
a turbine coupled to the electric generator;
wherein the auxiliary solid propellant grain is configured to burn to create an auxiliary high pressure gas for turning the turbine.

9. The auxiliary power generation arrangement of claim 8, further comprising a second valve in fluid communication with the turbine.

10. The auxiliary power generation arrangement of claim 9, further comprising a third valve for dumping pressure from the housing to extinguish the auxiliary solid propellant grain.

11. The auxiliary power generation arrangement of claim 10, wherein the auxiliary solid propellant grain is re-ignitable after being extinguished.

12. The auxiliary power generation arrangement of claim 8, wherein the auxiliary solid propellant grain is hermetically sealed from a primary solid propellant grain in response to the first valve moving to a closed position.

13. The auxiliary power generation arrangement of claim 11, further comprising a controller configured to control at least one of the first valve, the second valve, and the third valve for selectively powering the electric generator.

14. The auxiliary power generation arrangement of claim 13, further comprising a power supply configured to supply a second electric power to the controller.

15. The auxiliary power generation arrangement of claim 9, wherein the second valve is configured to meter the auxiliary high pressure gas to the turbine.

16. The auxiliary power generation arrangement of claim 10, wherein the third valve is configured to direct the auxiliary high pressure gas to an ambient environment.

17. A method for generating electric power for a rocket, the method comprising:
burning a primary solid propellant grain to create a primary high pressure gas for providing thrust to the rocket;
opening a first valve to divert a portion of the primary high pressure gas to an auxiliary solid propellant grain for igniting the auxiliary solid propellant grain, wherein the auxiliary solid propellant grain is disposed in a housing separate from the primary solid propellant grain;
burning the auxiliary solid propellant grain to create an auxiliary high pressure gas;
turning a turbine using the auxiliary high pressure gas;
driving a generator with the turbine; and
generating electric power with the generator.

18. The method of claim 17, further comprising:
closing the first valve;
hermetically sealing the auxiliary solid propellant grain from the primary solid propellant grain in response to the first valve closing;
opening a second valve; and
directing the auxiliary high pressure gas across the turbine in response to the second valve opening.

19. The method of claim 18, further comprising:
closing the second valve;
opening a third valve to decrease a pressure within the housing; and
extinguishing the auxiliary solid propellant grain in response to the pressure decreasing within the housing.

20. The method of claim 19, further comprising:
closing the third valve;
re-opening the first valve to divert a second portion of the primary high pressure gas to the auxiliary solid propellant grain; and
re-igniting the auxiliary solid propellant grain in response to the second portion of the primary high pressure gas being diverted to the auxiliary solid propellant grain.
